(19) United States
(12) Patent Application Publication
(10) Pub. No.: US 2016/0018293 A1
(43) Pub. Date: Jan. 21, 2016

(54) SINGLE-ENDED HIGH VOLTAGE TIRE INTEGRITY TESTING SYSTEMS AND METHODS

(71) Applicant: TEI Service, Inc., Columbia Heights, MN (US)

(72) Inventor: Dale A. Gustafson, Columbia Heights, MN (US)

(21) Appl. No.: 14/804,676

(22) Filed: Jul. 21, 2015

Related U.S. Application Data
(60) Provisional application No. 62/026,980, filed on Jul. 21, 2014.

(51) Int. Cl. G01M 17/02

(52) U.S. Cl. CPC G01M 17/02

(57) ABSTRACT

A system and methods for testing the integrity of a tire are disclosed. The tire is tested by powering a charging/timing circuit with a single-ended voltage supply. The single-ended voltage supply, via the charging/timing circuit, provides power to at least two test heads. The timing circuit can include various components that adjust the timing of the charge supplied.

### RELATED APPLICATION

The present application claims the benefit of U.S. Provisional Application No. 62/026,980 filed Jul. 21, 2014, which is incorporated herein in its entirety by reference.

### FIELD OF THE INVENTION

This invention relates generally to methods and apparatuses for detecting flaws in tires and, more specifically, to a high-voltage tire testing system for detecting the presence of nails and/or cuts and holes in tires for wheeled vehicles.

### BACKGROUND OF THE INVENTION

Conventional systems for tire retread rely on visual testing on used tire carcasses to ensure that they are free from cuts, holes and nails. In this regard, it is essential that the testing be accomplished in a minimum of time, yet with reliability so as to ensure that all defective carcasses are culled. The cuts and holes of culled carcasses can then be patched and the nails removed, prior to buffing and retreading.

While visual inspection is reasonably accurate, flaws frequently are missed, due either to human error or to the lack of visible evidence. Missed flaws, during retreading, can create problems in that high pressure air can force its way through the flaws and into the tire structure, causing separation, heat and degradation of the tire. The damaged tire can fail, either in the retread shop (“mold blows”) or on the road.

High voltage tire test methods are known that address some of these problems. High voltage tire test methods are known that can detect extremely small holes. High voltage testing can also be used to detect cuts or cracks in the inner liner that penetrate from the inside of the tire into the cord or tread rubber, but do not pass through the tire, or identify holes in tires that were retreaded with holes in them, the holes then being under the retread material and not extending through the tire. High voltage testing also can be used to identify offset holes, in which the hole path from the inside to the outside is not-in-line, but rather is connected by a channel through the cord. Additionally, high voltage testing can identify nails, screws, and the like that remain in the tire, which can then be removed after test, and the hole or internal separations in the tire can be patched. High voltage testing is relatively simple, fast, and the apparatus is relatively easy to use. The test does not require tire inflation, and thereby enables simultaneous visual inspection while performing a high-voltage inspection.

Despite these advantages, conventional high voltage tire testing systems suffer from several challenges. First, conventional high voltage tire tester systems often rely on simple step-up transformers to provide a spark. These step-up transformers provide a voltage roughly proportional to the input voltage, and as such cannot be easily adapted to discharge at a desired frequency. Discharging at a desired frequency is an advantage in some circumstances. Second, such conventional high voltage tire systems can malfunction and generate electrical arcs. These two challenges have been addressed at least in part through the use of digital power supplies that include two voltage generators combined in a push-pull arrangement (i.e., a double-ended power supply). These power supply systems tend to be relatively complex. Further, recently there has been a relative scarcity of supply for the types of double-ended power supplies used in conventional tire testing systems. Accordingly, a solution is needed which provides high voltage power via a relatively simple circuit which will not produce dangerous arcing, is tunable to various frequencies and/or spark voltages, and can be made from parts that are commercially available.

### SUMMARY

In embodiments, a single-ended high voltage power supply for a tire testing system, and methods for its use, are described herein. Due to advances in power supply technology over the last several decades, sufficiently high voltage can be provided by these single-ended supplies, while achieving the desired benefits of simplicity of circuitry, safety, and tunability. Conventional tire testing systems exclusively employed double-ended power supplies. The double-ended power supplies used in conventional systems are becoming less common and harder to acquire, leading to the need for a simpler, more readily-available alternative.

The above summary of the invention is not intended to describe each illustrated embodiment or every implementation of the present invention. The detailed description and claims that follow more particularly exemplify these embodiments.

### BRIEF DESCRIPTION OF THE DRAWINGS

FIG. 1 is a schematic diagram of a tire testing circuit, according to one embodiment; and

FIG. 2 is a schematic diagram of a tire testing circuit, according to another embodiment.

While embodiments are amenable to various modifications and alternative forms, specifics thereof have been shown by way of example in the drawings and will be described in detail. It should be understood, however, that the intention is not to be limited to the particular embodiments described. On the contrary, the intention is to cover all modifications, equivalents, and alternatives falling within the spirit and scope of the appended claims.

### DETAILED DESCRIPTION OF THE DRAWINGS

The following figures depict systems that can be used to test tires for irregularities and potential failure modes using a single ended high voltage DC power supply, using a circuit powered by a single-ended power supply. In some embodiments, the single-ended power supply is programmable to change the timing of tire testing voltage spikes.

Use of a single ended voltage supply reduces the cost and complexity of tire testing systems while providing the desired wave shape for charge and discharge of the testing circuitry. Although tire testing systems have existed for several decades, none thus far has incorporated a single-ended power supply. Some have included double-ended power supplies, while others attempt to use only a transformer rather operating off of line voltage than a dedicated power supply. Compared to a transformer, a dedicated power supply allows for a change in current or voltage to adjust the timing and/or intensity of the spark. Single-ended power supplies provide another advantage in that the required circuitry is simpler than that of a double-ended power supply.

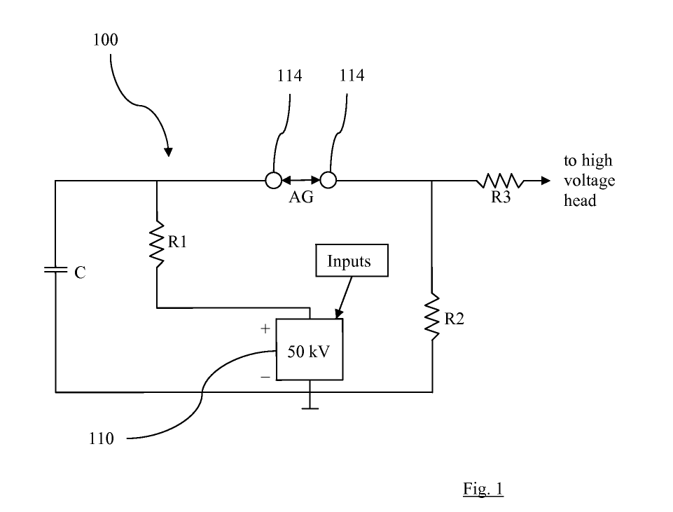

FIG. 1 is a circuit diagram of high voltage supply system 100. High voltage supply system 100 includes power source 110, which is a 50 kV, single ended high voltage DC power supply configured to operate based upon inputs 112. High voltage supply system 100 further includes first resistive system R1, second resistive system R2, third resistive system R3, capacitive system C, and two carbon balls 114.

High voltage supply system 100 is configured to provide pulses of high voltage power to a high voltage head (not shown). For example, high voltage supply system 100 can provide pulses of high output electrical power for a tire testing system.

Single ended power supply 110 is configured to provide up to 50 kV of potential to the systems to which it is connected. Unlike conventional systems, single ended power supply 110 is not a double ended, or “push-pull,” power supply. In order to achieve the required power output for a tire testing system using conventional double-ended power supplies, it is often necessary to use two such power supplies and combine them. In some embodiments, single ended power supply 110 can be a current-regulating power supply; that is, single ended power supply 110 will provide a maximum current output and no more. In embodiments, single ended power supply 110 can be a constant current source. In some embodiments, the maximum current output from single ended power supply 110 is 1.2 mA.

Inputs 112 are provided to single ended power supply 110 to facilitate control over single ended power supply 110. Inputs 112 can be, for example, a desired voltage output or a desired current output.

Carbon balls 114 are separated from one another by air gap AG. In the embodiment shown in FIG. 1, one of carbon balls 114 is connected to single ended power supply 110 by first resistive system R1 and capacitive system C. In particular, one of carbon balls 114 is separated from the positive output terminal of single ended power supply 110 by first resistive system R1, and is also separated from the negative output terminal of single ended power supply 110 (and ground) by capacitive system C. The second of carbon balls 114 is separated from ground by second resistive system R2. Furthermore, the second of carbon balls 114 is separated from the egress to the high voltage head by third resistive system R3.

In operation, single ended power supply 110 provides power to the first of carbon balls 114 through first resistive system R1. The voltage on the first of carbon balls 114 builds up as charge builds on capacitive system C. At some point, when the charge buildup on capacitive system C and the voltage on the first of carbon balls 114 increases sufficiently, an arc forms across air gap AG, and current flows both through second resistive system R2 to ground and through third resistive system R3 to a high voltage head.

By tuning the sizing and/or spacing of various components in high voltage supply system 100, different output voltages and timings can be generated. For example, charge buildup time can be adjusted by changing the DC output current from single ended power supply 110, or by changing the capacitance of capacitive system C. This interrelationship can be described by the equation:

$$I = \frac{C \cdot V}{t}$$

So, for example, in one embodiment a tire integrity sensor includes a high voltage head and the operator desires to charge the voltage head to 43 kV every 25 ms. The system 100 of FIG. 1 can include, for example, a capacitive system C having a capacitance of 500 pF, voltage supply of 50 kV (or higher), t=25 ms and, accordingly, I=0.86 mA. In embodiments, the claimed invention includes the ability to program the current output, which can achieve variations in the charge time as desired. This functionality is not known in the prior art.

It should be understood that the various resistive and capacitive systems shown in FIG. 1 could be made up of various subsystems. For example, capacitive system C could be made up of several capacitors arranged in parallel or in series in order to generate a desired capacitance. In addition, resistive systems R1, R2, and R3 could be made up of various components to achieve a desired overall impedance. These subsystems can be generated according to several criteria.

First, subsystems are often constructed based on component availability. For example, a particular desired resistance can be generated by combining several resistors having standard sizes (i.e., forming a Thévenin equivalent circuit). Likewise, several capacitors having standard sizes can be combined in series or in parallel to create a desired overall capacitance.

Second, some components can have stray resistances, capacitances, and/or inductances. In some contexts, these stray phenomena can be undesirable. However, in the resistive and capacitive systems used herein, they can be beneficial in that they can be used to shape the waveform of the voltage present at the high voltage head. For example, in some embodiments stray resistance and capacitance at various positions can form RC circuits that smooth the waveform.

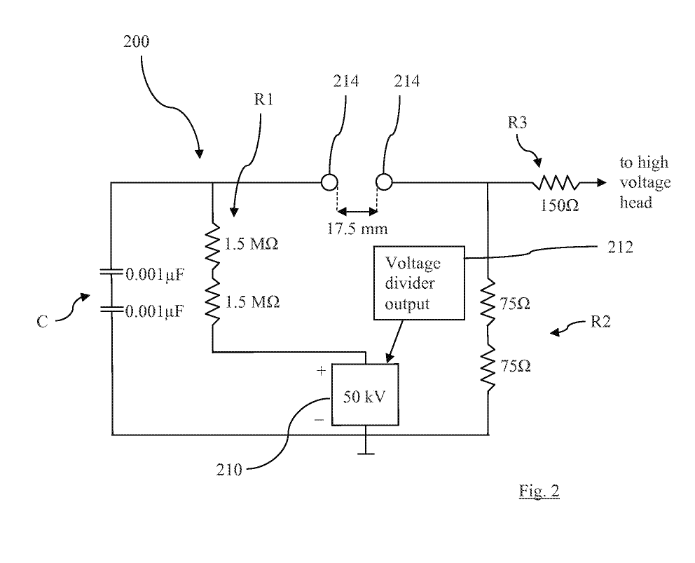

FIG. 2 is a schematic diagram of a high voltage supply system 200, according to an embodiment. As previously described, FIG. 1 illustrates a high voltage supply system 100 using a single-ended high voltage power supply 110 generally. FIG. 2 illustrates one potential embodiment of that system.

In particular, Air Gap AG of FIG. 1 is shown as a 17.5 mm gap between adjacent carbon balls 214 of FIG. 2. In alternative embodiments, the air gap could be larger or smaller. Changing the spacing of the carbon balls 214 results in a different breakdown voltage, which affects the timing of the circuit.

Furthermore, capacitive system C comprises two capacitors each having a 0.001 μF capacitance. Thus, the overall capacitance of capacitive system C is

$$\frac{1}{( \frac{1}{0.001} + \frac{1}{0.001} )} μF = 500 pF .$$

In alternative embodiments, larger or smaller overall capacitance can be used in order to affect the timing of the circuit. Furthermore, in various embodiments, other capacitors can be added in parallel or series with those shown in FIG. 2 to create a desired overall capacitance for capacitive system C.

Resistive systems R1 and R2 each comprise two resistors. In particular, first resistive system R1 comprises two 1.5 MΩ resistors arranged in series, and second resistive system R2 comprises two 75Ω resistors in series. In various embodiments, other resistors can be added in parallel or series with those shown in FIG. 2 to create a desired overall resistance for each of resistive systems R1 and R2.

Furthermore, inputs 112 of FIG. 1 are shown as voltage divider output 212. In the embodiment shown in FIG. 2, high voltage power supply 210 is programmable. That is, high voltage power supply 210 can be driven to produce a desired DC current output to control the timing of the circuit. The current output of high voltage power supply 210 can be programmable by using a resistive voltage divider to select a percentage from a provided reference voltage. If the reference voltage is 10 volts, for example, and a user's intention is to obtain the full current output, then the entire 10 volt reference can be fed back to the current program input. Alternatively, if the desired current output is less than the maximum, then the current program input can be reduced proportionally to generate the desired output. Various embodiments of systems, devices and methods have been described herein. These embodiments are given only by way of example and are not intended to limit the scope of the invention. It should be appreciated, moreover, that the various features of the embodiments that have been described can be combined in various ways to produce numerous additional embodiments. Moreover, while various materials, dimensions, shapes, configurations and locations, etc. have been described for use with disclosed embodiments, others besides those disclosed can be utilized without exceeding the scope of the invention.

Persons of ordinary skill in the relevant arts will recognize that the invention can comprise fewer features than illustrated in any individual embodiment described above. The embodiments described herein are not meant to be an exhaustive presentation of the ways in which the various features of the invention can be combined. Accordingly, the embodiments are not mutually exclusive combinations of features; rather, the invention can comprise a combination of different individual features selected from different individual embodiments, as understood by persons of ordinary skill in the art. Moreover, elements described with respect to one embodiment can be implemented in other embodiments even when not described in such embodiments unless otherwise noted.

1. A method for operating an electrical circuit for tire testing, the method comprising:
providing an electrical circuit configured to power at least two test heads of a tire tester system;
providing an input voltage to the electrical circuit with a single-ended high voltage power supply configured to provide pulses of high voltage power to the at least two test heads; and
modifying a current level in the circuit to achieve a desired charge time of the at least two test heads.

2. The method of claim 1, wherein modifying the current comprises setting the current to a capacitance of the circuit times the input voltage divided by the desired charge time.

3. The method of claim 2, wherein the charge time is about 25 milliseconds.

4. The method of claim 3, wherein the capacitance is about 500 pF.

5. The method of claim 4, wherein the capacitance is provided by at least one capacitor arranged between at least one of the two high voltage heads and the single-ended high voltage power supply.

6. The method of claim 3, wherein the input voltage is about 50 kV.

7. The method of claim 1, wherein the at least two test heads each include a carbon ball.

8. The method of claim 1, wherein the at least two test heads are separated from one another by an air gap.

9. The method of claim 8, and further comprising positioning a tire in the air gap.

10. A system for detecting flaws in a tire, the system comprising:
at least two test heads spaced apart from one another;
an electrical circuit configured to provide high voltage power to the at least two test heads sufficient to generate a spark through a tire positioned between the at least two heads; and
a single-ended power supply configured to provide power to the electrical circuit, wherein the electrical circuit is configured to provide a voltage difference between the at least two test heads at a predetermined charge rate.

11. The system of claim 10, wherein the circuit includes both a resistive element and a capacitive element configured to form a timing circuit.

12. The system of claim 11, wherein the timing circuit has a charge time of about 25 milliseconds.

13. The system of claim 11, wherein the resistive element has a resistance of about 3 MΩ.

14. The system of claim 11, wherein the capacitive element has a capacitance of about 500 pF.

15. The system of claim 10, wherein the test heads are separated from one another by an air gap.

16. The system of claim 15, wherein the air gap is configured to receive a tire to be tested by the system.

17. A method of testing a tire for flaws, the method comprising:
positioning a tire in an air gap located between at least two test heads;
powering a charging circuit with a single-ended power supply, wherein the charging circuit delivers power to the at least two test heads.

18. The method of claim 17, wherein the charging circuit includes both a resistive element and a capacitive element configured to form a timing circuit.

19. The method of claim 18, wherein the resistive element has a resistance of about 3 MΩ.

20. The method of claim 18, wherein the capacitive element has a capacitance of about 500 pF.
